(19) United States
(12) Patent Application Publication
(10) Pub. No.: US 2026/0056012 A1
(43) Pub. Date: Feb. 26, 2026

(54) LIGHT DETECTION DEVICE AND LIGHT DETECTION SYSTEM

(71) Applicant: SONY SEMICONDUCTOR SOLUTIONS CORPORATION, KANAGAWA (JP)

(72) Inventor: HISASHI YONEYAMA, KANAGAWA (JP)

(21) Appl. No.: 19/104,270

(22) PCT Filed: Jul. 27, 2023
(86) PCT No.: PCT/JP2023/027591

§ 371 Date: Feb. 17, 2025

(30) Foreign Application Priority Data
Aug. 24, 2022 (JP) 2022-133603

(51) Int. Cl. G01B 11/25; G01C 3/06; G01C 3/10; G06T 5/80; G06T 7/521; G06T 7/70

(52) U.S. Cl. CPC G01B 11/25; G01C 3/06; G01C 3/10; G06T 5/80; G06T 7/521; G06T 7/70

(57) ABSTRACT

[Problem] The present disclosure provides a light detection device and a light detection system capable of measuring a three-dimensional shape more efficiently.

[Means of Solution] The present disclosure provides a light detection device including: an imaging unit that captures a measurement range in which a projection image having a pattern determined in advance is projected; and a signal processing unit that generates three-dimensional distance data for the measurement range on the basis of captured image data captured by the imaging unit, in which the signal processing unit includes a distortion correction unit that corrects distortion of a two-dimensional coordinate based on the captured image data.

### TECHNICAL FIELD

The present disclosure relates to a light detection device and a light detection system.

### BACKGROUND ART

There is known a light detection device that includes a projector and a camera and that measures the three-dimensional shape of an object by pattern projection.

### CITATION LIST

### Patent Literature

### [PTL 1]

WO 2018/168757

### SUMMARY

### Technical Problem

Such a light detection device occasionally corrects distortion of an epipolar line using distortion parameters calculated on the basis of distance information, and recalculates the position of a three-dimensional point. Since distortion correction is performed while adaptively varying the distortion parameters on the basis of the distance, however, the amount of computation may be enormous. Therefore, there may be a fear of an increase in circuit size and a degradation in latency.

Thus, the present disclosure provides a light detection device and a light detection system capable of measuring a three-dimensional shape more efficiently.

### Solution to Problem

In order to solve the above problem, the present disclosure provides a light detection device including:
an imaging unit that captures a measurement range in which a projection image having a pattern determined in advance is projected; and
a signal processing unit that generates three-dimensional distance data for the measurement range on the basis of captured image data captured by the imaging unit, in which
the signal processing unit includes a distortion correction unit that corrects distortion of a two-dimensional coordinate based on the captured image data.

The light detection device may further include a projection unit that projects the projection image.

The imaging unit may include an imaging optical system;
the projection unit may include a projection optical system; and
an optical axis of the imaging optical system and an optical axis of the projection optical system may be parallel.

The distortion correction unit may perform distortion correction in accordance with r to the second power based on an x coordinate of the captured image data to the second power and a y coordinate of the captured image data to the second power.

The signal processing unit may further include a distance measurement unit that generates three-dimensional distance data for the measurement range on the basis of the captured image data that have been subjected to a distortion correction process by the distortion correction unit.

The distortion correction unit may correct the captured image data such that an epipolar line approximates to a straight line.

The distortion correction unit may include
a first distortion correction unit that corrects the captured image data such that an epipolar line approximates to a straight line, and
a second distortion correction unit that has a high computation speed and a suppressed correction accuracy compared to the first distortion correction unit; and
the distortion correction unit may perform distortion correction by selecting one of the first distortion correction unit and the second distortion correction unit in accordance with a predetermined condition.

The distortion correction unit may further include a determination unit that determines which of the first distortion correction unit and the second distortion correction unit to use in accordance with a predetermined condition.

The determination unit may determine which of the first distortion correction unit and the second distortion correction unit to use in accordance with an imaging magnification of the imaging optical system.

The distortion correction unit may be capable of performing distortion correction in accordance with r to the second power based on an x coordinate of the captured image data to the second power and a y coordinate of the captured image data to the second power;
the first distortion correction unit may perform distortion correction on the basis of r to the second power, r to the fourth power, and r to the sixth power; and
the second distortion correction unit may perform distortion correction on the basis of r to the second power and r to the fourth power.

The distance measurement unit may extract a characteristic point in one direction of the captured image data after the distortion correction.

The distance measurement unit may generate the three-dimensional distance data using a principle of triangulation.

The signal processing unit may include:
a second distortion correction unit that corrects the captured image data such that an epipolar line in the captured image data approximates to a straight line;
a distance measurement unit that generates the three-dimensional distance data on the basis of the captured image data that have been subjected to distortion correction by the second distortion correction unit; and
a first distortion correction unit that corrects a two-dimensional coordinate of the three-dimensional distance data such that an epipolar line at the two-dimensional coordinate further approximates to a straight line.

The light detection device may further include a region-of-interest reading unit that restricts a range of image data, and
the signal processing unit may generate three-dimensional distance data for the measurement range in the restricted range.

The signal processing unit may further include a distance measurement unit that generates the three-dimensional distance data on the basis of the captured image data; and
the distortion correction unit may correct a two-dimensional coordinate of the three-dimensional distance data such that an epipolar line at the two-dimensional coordinate approximates to a straight line.

The first distortion correction unit and the second distortion correction unit may share a processing unit that computes r to the second power and r to the fourth power.

A light detection system may include:
a projection device that projects a projection pattern determined in advance in a measurement range via a projection optical system;
an imaging device that captures the measurement range in which the projection pattern is projected via an imaging optical system; and
a processing device that generates three-dimensional distance data for the measurement range on the basis of captured image data captured by the imaging device, and
the processing device may include a distortion correction unit that corrects distortion of a two-dimensional coordinate based on the captured image data.

In order to solve the above problem, the present disclosure provides a light detection system including:
a projection device that projects a projection pattern determined in advance in a measurement range via a projection optical system;
an imaging device that captures the measurement range in which the projection pattern is projected via an imaging optical system; and
a processing device that generates three-dimensional distance data for the measurement range on the basis of captured image data captured by the imaging device, in which
the processing device includes a distortion correction unit that corrects distortion of a two-dimensional coordinate based on the captured image data.

An optical axis of the projection optical system and an optical axis of the imaging optical system may be parallel; and
the distortion correction unit may correct the captured image data such that an epipolar line approximates to a straight line.

In order to solve the above problem, the present disclosure provides a light detection system including:
a projection device that projects a projection pattern determined in advance in a measurement range via a projection optical system;
a first imaging device that captures the measurement range in which the projection pattern is projected via a first imaging optical system; and
a second imaging device that captures the measurement range in which the projection pattern is projected via a second imaging optical system, in which:
the second imaging device includes a signal processing unit that generates three-dimensional distance data for the measurement range on the basis of first captured image data captured by the first imaging device and second captured image data captured by the second imaging device; and
the signal processing unit includes a distortion correction unit that corrects distortion of a two-dimensional coordinate of the first captured image data and a two-dimensional coordinate of the second captured image data.

An optical axis of the first imaging optical system and an optical axis of the second imaging optical system may be parallel; and
the distortion correction unit may correct the first captured image data and the second captured image data such that an epipolar line approximates to a straight line.

### BRIEF DESCRIPTION OF DRAWINGS

FIG. 1 illustrates an example of a schematic configuration of a light detection device to which the present technology is applied.

FIG. 2 is a block diagram illustrating an example of the configuration of the light detection device.

FIG. 3 illustrates an example of a process by a lens distortion correction unit.

FIG. 4 is a block diagram illustrating an example of the configuration of a distance measurement unit.

FIG. 5 illustrates an example of a process by a binarization processing unit.

FIG. 6 illustrates an example of a process of triangulation performed using the coordinate of a characteristic point.

FIG. 7 illustrates the relationship between a coordinate in an image before being corrected and a coordinate after being corrected.

FIG. 8 illustrates examples of images related to distortion parameters.

FIG. 9 schematically illustrates an example of a process by a distortion correction unit.

FIG. 10 schematically illustrates an example of a process performed by the distortion correction unit using distortion parameters.

FIG. 11 conceptually illustrates a situation in which the distortion parameters of the distortion correction unit have a correction effect.

FIG. 12 is a block diagram illustrating an example of the configuration of a distortion correction unit according to a second embodiment.

FIG. 13 is a flowchart illustrating examples of processes by a first distortion correction unit and a second distortion correction unit.

FIG. 14 is a block diagram illustrating an example of the configuration of a processing unit according to a third embodiment.

FIG. 15 is a block diagram illustrating an example of the configuration of a light detection device according to a fourth embodiment.

FIG. 16 is a block diagram illustrating an example of the configuration of a processing unit according to a fifth embodiment.

FIG. 17 is a block diagram illustrating an example of the configuration of a distortion correction unit according to a sixth embodiment.

FIG. 18 illustrates an example of the configuration of a light detection system according to a seventh embodiment.

FIG. 19 illustrates an example of the configuration of a light detection system according to an eighth embodiment.

### DESCRIPTION OF EMBODIMENTS

Hereinafter, embodiments of a light detection device and a light detection system will be described with reference to the drawings. While main components of the light detection device and the light detection system will be mainly described hereinafter, components or functions that are not illustrated or described may be present in the light detection device and the light detection system. The following description does not exclude components or functions that are not illustrated or described.

### First Embodiment

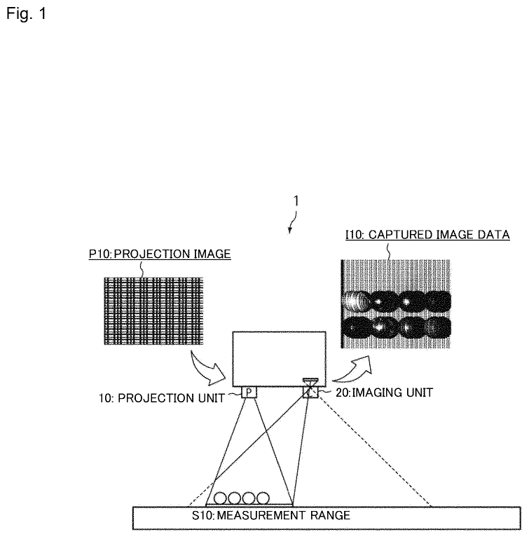

FIG. 1 illustrates an example of a schematic configuration of a light detection device to which the present technology is applied. A light detection device 1 illustrated in FIG. 1 includes at least a projection unit 10 and an imaging unit 20, for example.

The light detection device 1 is configured as a device that can be made smaller, as a portable device, for example.

The projection unit 10 is a projector, for example, and generates a projection image P10 having two levels of brightness, that is, a bright part and a dark part, and projects the projection image P10 in a measurement range S10. The projection image P10 is a grid pattern such as that illustrated in FIG. 1, for example. In this grid pattern, characteristic points having a peculiar geographic shape are arranged in a two-dimensional grid shape. A characteristic amount is allocated to each characteristic point as its peculiar code, for example.

A three-dimensional coordinate relative to the principal point position of the projection unit 10 has been allocated in advance to each characteristic point. While the projection image P10 is a grid pattern, this is not limiting. For example, the projection image P10 may be pattern light, or the like, in which a plurality of spots SP form the bright part and the other regions forms the dark part, the spots SP being formed to have the shape of dots arranged at predetermined regular or irregular intervals.

The imaging unit 20 is a camera, for example, and captures the projection image P10 in the measurement range S10 as captured image data I10. The light detection device 1 detects the coordinates of characteristic points on the captured image I10, and generates a distance value of the measurement range S10 from the principal point position of the projection unit 10 or the imaging unit 20 by the principle of triangulation as discussed later.

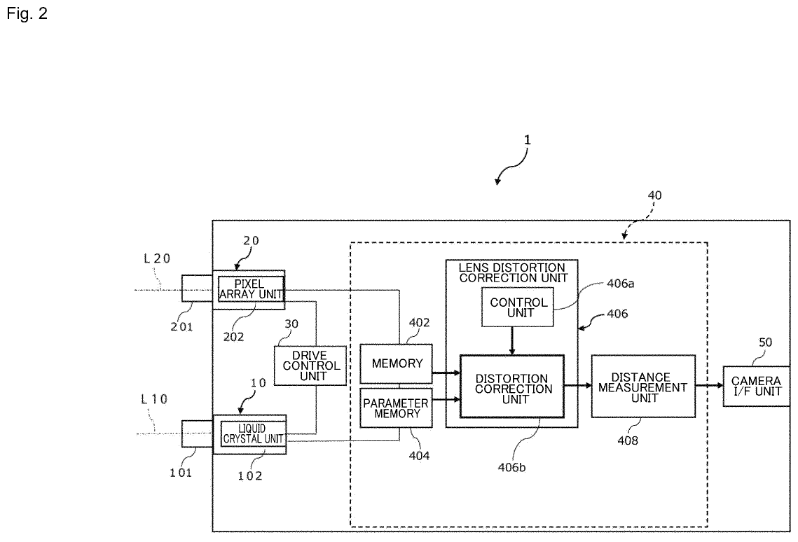

FIG. 2 is a block diagram illustrating an example of the configuration of the light detection device 1. As illustrated in FIG. 2, the light detection device 1 includes a projection unit 10, an imaging unit 20, a drive control unit 30, a signal processing unit 40, and a camera interface unit 50.

The projection unit 10 includes a projection optical system 101 that has an optical axis L10 and a liquid crystal unit 102. The liquid crystal unit 102 generates a two-dimensional projection image P10 as a brightness image. In the projection image P10, a position in the row direction is defined as an xp coordinate, and a position in the column direction is defined as a yp coordinate. The liquid crystal unit 102 generates the projection image P10 as a brightness image using raw data on the projection image P10 (see FIG. 1) stored in a memory 402 to be discussed later, for example. This allows the projection unit 10 to project the projection image P10 in the measurement range S10 via the projection optical system 101 as discussed above.

The imaging unit 20 includes an imaging optical system 201 that has an optical axis L20 and an image array unit 202 in which imaging elements are arranged two-dimensionally. The optical axis L10 and the optical axis L20 are parallel. The image array unit 202 is a CMOS (Complementary Metal Oxide Semiconductor) image sensor, for example. That is, the image array unit 202 captures the projection image P10 (see FIG. 1) in the measurement range S10 via the imaging optical system 201, and generates captured image data I10. In the image array unit 202, a position in the row direction is defined as an x coordinate, and a position in the column direction is defined as a y coordinate.

The drive control unit 30 is configured to include a CPU (Central Processing Unit), for example. The drive control unit 30 controls the projection unit 10 and the imaging unit 20 on the basis of an input signal from an operation unit (not illustrated), for example.

The signal processing unit 40 is configured, on a single semiconductor substrate, to include a CPU (Central Processing Unit), for example. That is, the signal processing unit 40 includes a memory 402, a parameter memory 404, a lens distortion correction unit 406, and a distance measurement unit 408. The lens distortion correction unit 406 according to the present embodiment corresponds to a distortion correction unit.

The memory 402 can store a predetermined program for the signal processing unit 40, and store raw data for the projection image P10 (see FIG. 1) and the captured image data I10. The parameter memory 404 stores a coordinate in association with each characteristic point of the projection image P10 and a characteristic amount obtained by digitalizing the geometric characteristic of the characteristic point.

In addition, the memory 402 stores the principal point position of the projection unit 10, the principal point position of the imaging unit 20, the distance between the principal point positions, distortion parameters of the imaging optical system 201 of the imaging unit 20, etc., which are required for distance computation to be discussed later. That is, the signal processing unit 40 generates a distance value from the principal point position of the measurement range S10 by performing signal processing using the information stored in the parameter memory 404 in accordance with the program stored in the memory 402.

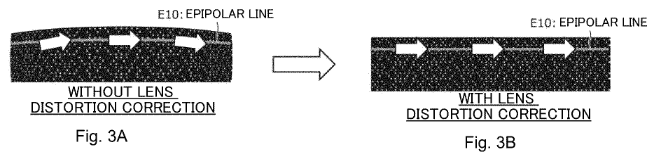

FIG. 3 illustrates an example of a process by the lens distortion correction unit 406. A in the drawing illustrates the captured image data I10 before being processed by the lens distortion correction unit 406 as a two-dimensional image, and B in the drawing illustrates captured image data I10a after being processed by the lens distortion correction unit 406 as a two-dimensional image. Since the optical axis L10 and the optical axis L20 are parallel, an epipolar line E10 after lens distortion correction is a straight line, and parallel to the row direction of the image array unit 202. The lens distortion correction unit 406 will be discussed in detail later.

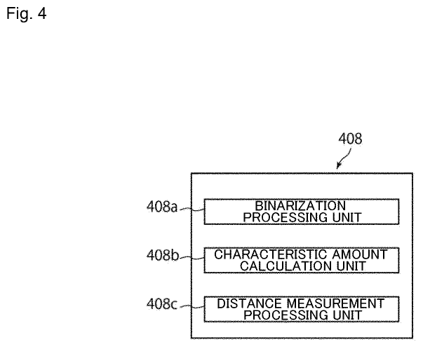

The distance measurement unit 408 will be described with reference to FIGS. 4 to 6. FIG. 4 is a block diagram illustrating an example of the configuration of the distance measurement unit 408. As illustrated in FIG. 4, the distance measurement unit 408 performs a distance measurement process using the captured image data I10a after a correction process by the lens distortion correction unit 406. That is, the distance measurement unit 408 includes a binarized signal processing unit 408a, a characteristic amount calculation unit 408b, and a distance measurement signal processing unit 408c.

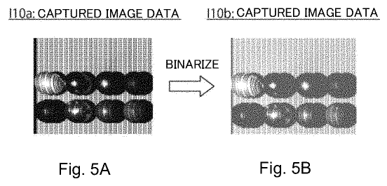

FIG. 5 illustrates an example of a process by the binarized signal processing unit 408a. A in the drawing illustrates the captured image data I10a after being processed by the lens distortion correction unit 406 as a two-dimensional image, and B in the drawing illustrates captured image data I10b after being processed by the binarized signal processing unit 408a as a two-dimensional image. As illustrated in FIG. 5, the binarized signal processing unit 408a generates captured image data I10b having binary values on the basis of the captured image data I10a in accordance with a predetermined threshold.

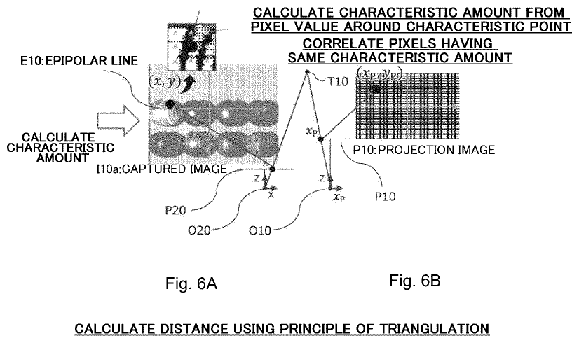

FIG. 6 illustrates an example of a process of triangulation performed using the coordinate of a characteristic point. C in the drawing illustrates an example of a process of extracting a characteristic point from the captured image data I10b having binary values, and D in the drawing illustrates the coordinate of the projection image P10 corresponding to the characteristic point.

As illustrated in C in FIG. 6, the epipolar line E10 (see FIG. 3) after a binarization process by the lens distortion correction unit 406 is a straight line. Therefore, the characteristic amount calculation unit 408b extracts a characteristic point (x, y) and calculates a characteristic amount along the row direction of the captured image data I10b after the binarization process. For example, the characteristic amount calculation unit 408b extracts the coordinate of an edge as a characteristic point, and calculates a characteristic amount using pixels values around the characteristic point.

In this case, since the epipolar line E10 (see FIG. 3) is a straight line, the characteristic amount calculation unit 408b can extract a characteristic point along the coordinate in the row direction. Further, since the image has been corrected also in the range of calculation of the pixel values around the characteristic point, a characteristic amount can be calculated from a range with a predetermined width in the column direction from the characteristic point. Therefore, a characteristic amount can be computed at a higher speed. This increases latency and enhances the accuracy in computation of a characteristic amount.

When an image (see FIG. 3A) before being corrected is used, on the contrary, it is necessary to extract a characteristic point and compute a characteristic amount from a range in the column direction for the curve width of the epipolar line E10 or more, in order to extract a characteristic point in the row direction. Therefore, when an image (see FIG. 3A) before being corrected is used, the computation amount may be several tens to several thousands of times, for example, compared to when an image (see FIG. 3B) after being corrected is used. As can be understood from this description, when an image (see FIG. 3B) after being corrected is used, the memory capacity required to compute a characteristic amount also can be reduced compared to when an image (see FIG. 3A) before being corrected is used.

The distance measurement signal processing unit 408c acquires the coordinate (xp, yp) of the characteristic point corresponding to the characteristic amount of the characteristic point from the parameter memory 404. As illustrated in FIG. 6, the coordinates of a principal point position O10 of the projection unit 10 and a display surface P10 of the liquid crystal unit 102 are known. Similarly, the coordinate of a display surface P20 of the image array unit 202 of the imaging unit 20 is known. Therefore, the coordinate (x, y) of the characteristic point and the three-dimensional coordinate of the coordinate (xp, yp) corresponding to the characteristic point can be generated for the principal point position coordinate O10. Further, the distance between the principal point positions O10 and O20 is also known. As can be understood from these, the distance measurement signal processing unit 408c can compute a three-dimensional coordinate (x, y, z) of a measurement point T10 by the principle of triangulation using the coordinate (x, y) of the characteristic point and the coordinate (xp, yp) of the corresponding point. In this manner, the distance measurement signal processing unit 408c can generate three-dimensional distance data for the measurement range S10 (see FIG. 1). The camera interface unit 50 is an interface between the light detection device 1 and an external device.

Here, the lens correction unit 406 will be described in detail. Again, as illustrated in FIG. 2, the lens correction unit 406 includes a control unit 406a and a distortion correction unit 406b. The control unit 406a controls the distortion correction unit 406b in conjunction with the drive control unit 30.

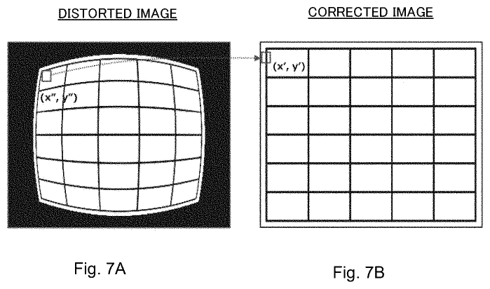

The distortion correction unit 406b performs a correction process for the captured image data I10 using parameters stored in the parameter memory 404. FIG. 7 illustrates the relationship between a coordinate (x″, y″) in an image before being corrected and a coordinate (x′, y′) after being corrected. A in the drawing is a distorted image before being corrected, and B in the drawing is a corrected image after being corrected. The parameter memory 404 stores distortion parameters k1, k2, k3, p1, and p2 in formulas (1) and (2), for example. The distortion parameters can be calculated through advance calibration by a technique by Zhang, for example, and have been acquired in advance. The distortion parameters k1, k2, and k3 are occasionally referred to as distortion parameters in the radial direction, and the distortion parameters p1 and p2 are occasionally referred to as distortion parameters in the circumferential direction.

$$\begin{matrix}[ Math . 1 ] & \\ {x}^{′} = x \text{?} ( 1 + {k}_{1} {r}^{2} + {k}_{2} {r}^{4} + {k}_{3} {r}^{6} ) + 2 {p}_{1} x \text{?} y \text{?} + {p}_{2} ( {r}^{2} + 2 x {\text{?}}^{2} ) & ( 1 )\end{matrix}$$

$$\begin{matrix}[ Math . 2 ] & \\ {y}^{′} = y \text{?} ( 1 + {k}_{1} {r}^{2} + {k}_{2} {r}^{4} + {k}_{3} {r}^{6} ) + 2 {p}_{2} x \text{?} y \text{?} + {p}_{1} ( {r}^{2} + 2 y {\text{?}}^{2} ) & ( 2 )\end{matrix}$$

$$Here ,$$

$$\begin{matrix}[ Math . 3 ] & \\ {r}^{2} = x {\text{?}}^{2} + y {\text{?}}^{2} & ( 3 )\end{matrix}$$

$$\text{?} \text{indicates text missing or illegible when filed}$$

The distortion correction unit 406b according to the present embodiment generates distortion-corrected captured image data I10a (x′, y′) from the captured image data 110 (x″, y″) using the distortion parameters k1, k2, k3, p1, and p2 stored in the parameter memory 404.

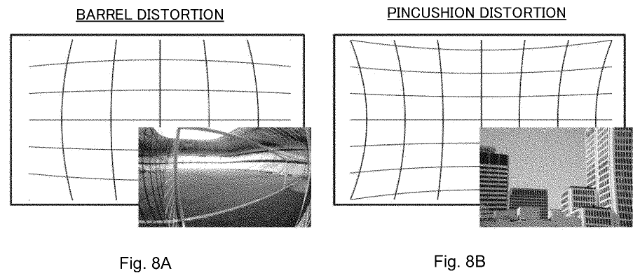

Here, the relationship between the distortion parameters k1, k2, k3, p1, and p2 and the corrected image will be described with reference to FIGS. 8 to 11. FIG. 8 illustrates examples of images related to the distortion parameters k1, k2, and k3. A in the drawing is an image example referred to as a barrel type, and B in the drawing is an image example referred to as a pincushion type.

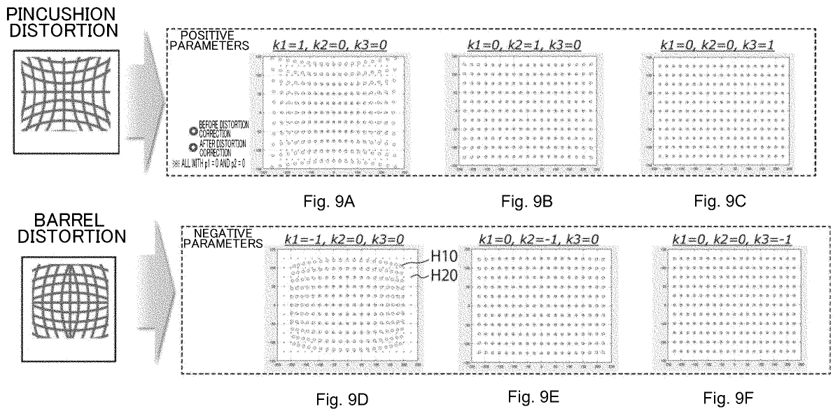

FIG. 9 schematically illustrates an example of a process by the distortion correction unit 406b. A in the drawing is a process example with the distortion parameters k1=1, k2=0, and k3=0, B in the drawing is a process example with the distortion parameters k1=0, k2=1, and k3=0, and C in the drawing is a process example with the distortion parameters k1=0, k2=0, and k3=1. D in the drawing is a process example with the distortion parameters k1=−1, k2=0, and k3=0, E in the drawing is a process example with the distortion parameters k1=0, k2=−1, and k3=0, and F in the drawing is a process example with the distortion parameters k1=0, k2=0, and k3=−1. H10 indicated by large circles indicates coordinates before being corrected, and H20 indicated by small circles indicates coordinates after being corrected.

As can be understood from these drawings, a correction effect can be obtained for an image with pincushion distortion when the distortion parameters k1, k2, and k3 are positive. In addition, the correction effect becomes smaller in the order of k1, k2, and k3. For example, for the same value 1, the range of change of the coordinates after being corrected is the smallest for k3.

On the other hand, a correction effect can be obtained for an image with barrel distortion when the distortion parameters k1, k2, and k3 are negative. In addition, the correction effect becomes smaller in the order of k1, k2, and k3. For example, for the same value 1, the range of change of the coordinates after being corrected is the smallest for k3.

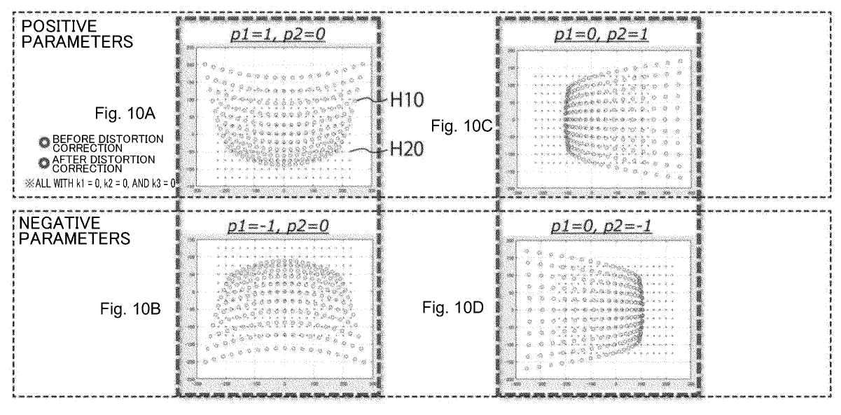

FIG. 10 schematically illustrates an example of a process performed by the distortion correction unit 406b using the distortion parameters p1 and p2. A in the drawing is a process example with the distortion parameters p1=1 and p2=0, B in the drawing is a process example with the distortion parameters p1=−1 and p2=0, and C in the drawing is a process example with the distortion parameters p1=0 and p2=1. D in the drawing is a process example with the distortion parameters p1=0 and p2=−1. H10 indicated by large circles indicates coordinates before being corrected, and H20 indicated by small circles indicates coordinates after being corrected.

As can be understood from these drawings, a correction effect can be obtained for an upwardly curved image when the distortion parameter p1 is positive. A correction effect can be obtained for a downwardly curved image when the distortion parameter p1 is negative. A correction effect can be obtained for a rightwardly curved image when the distortion parameter p2 is positive. A correction effect can be obtained for a leftwardly curved image when the distortion parameter p2 is negative.

FIG. 11 conceptually illustrates a situation in which the distortion parameters p1 and p2 of the distortion correction unit 406b have a correction effect. FIG. 11 schematically illustrates a cross section of a lens L200 of an optical system 210 (see FIG. 1) and the pixel array unit 202. A in the drawing is an example in which the surface of the pixel array unit 202 and the optical axis L20 of the lens L200 of the optical system 210 (see FIG. 1) are orthogonal, and B in the drawing is an example in which the surface of the pixel array unit 202 and the optical axis L20 of the lens L200 of the optical system 210 (see FIG. 1) are not orthogonal. Correction by the distortion parameters p1 and p2 is effective when the surface of the pixel array unit 202 and the optical axis L20 of the lens L200 of the optical system 210 (see FIG. 1) are not orthogonal as illustrated in B in the drawing. In the light detection device 1 according to the present embodiment, when the alignment of the optical system, etc., of the light detection device 1 meets a criterion in an inspection at the time of manufacture, for example, the correction effect of the distortion parameters p1 and p2 is reduced, and thus it is not necessary to use the distortion parameters p1 and p2, with p1=0 and p2=0.

In the present embodiment, as described above, the lens distortion correction unit 406 corrects the captured image I10 such that the epipolar line E10 is a straight line. This makes it possible to restrict the range of computation of a characteristic point by the distance measurement unit 408 within a predetermined range of the image in the column direction. Therefore, the distance measurement unit 408 can perform computation in one direction in the row direction with the extraction of a characteristic point and the computation of a characteristic amount restricted within a predetermined range of the image in the column direction, and thus it is possible to suppress the number of times of computation processing in distance measurement, and to improve the measurement accuracy.

### Second Embodiment

A light detection device 1 according to a second embodiment is different from the light detection device 1 according to the first embodiment in that the number of distortion parameters to be used for correction in the correction process by the lens distortion correction unit 406 is changed in accordance with the distortion of an image. The differences from the light detection device 1 according to the first embodiment will be described below.

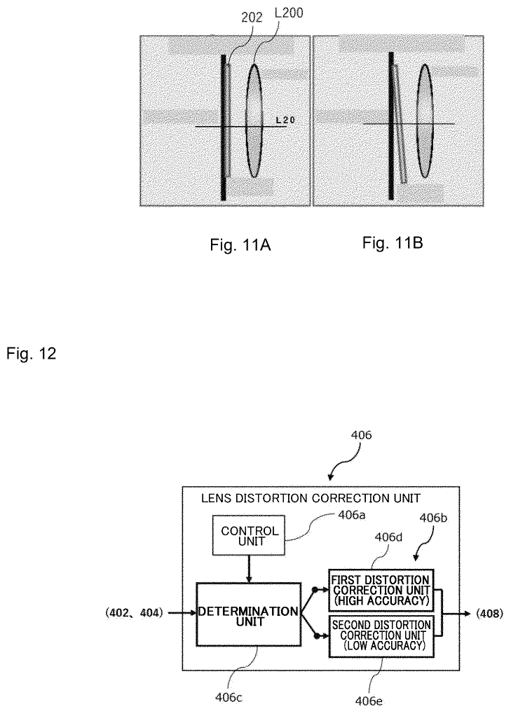

FIG. 12 is a block diagram illustrating an example of the configuration of a lens distortion correction unit 406 according to the second embodiment. As illustrated in FIG. 12, the lens distortion correction unit 406 according to the second embodiment further includes a determination unit 406c, and the distortion correction unit 406b includes a first distortion correction unit 406d and a second distortion correction unit 406e.

The determination unit 406c determines which of the first distortion correction unit 406d and the second distortion correction unit 406e to use for distortion correction. The determination unit 406c selects one of the first distortion correction unit 406d and the second distortion correction unit 406e with reference to a value set in the parameter memory 404 by a user as register setting. The determination unit 406c may also select one of the first distortion correction unit 406d and the second distortion correction unit 406e to use on the basis of an accuracy estimated from a calibration result. More specifically, the determination unit 406c selects one of the first distortion correction unit 406d and the second distortion correction unit 406e in accordance with the magnitude of each of the distortion parameters k1, k2, and k3.

For example, the first distortion correction unit 406d is used when the value of k3 is more than a predetermined value.

The first distortion correction unit 406d is used when correction is performed with higher accuracy using formulas (4) and (5), for example. That is, the first distortion correction unit 406d according to the present embodiment uses the distortion parameters k1, k2, and k3. In the light detection device 1 according to the present embodiment, the alignment of the optical system, etc., of the light detection device 1 meets a criterion in an inspection at the time of manufacture, for example, and thus an example in which the distortion parameters p1 and p2 are not used, with p1=0 and p2=0, will be described.

$$\begin{matrix}[ Math . 4 ] & \\ {x}^{′} = x \text{?} ( 1 + {k}_{1} {r}^{2} + {k}_{2} {r}^{4} + {k}_{3} {r}^{6} ) & ( 4 )\end{matrix}$$

$$\begin{matrix}[ Math . 5 ] & \\ {y}^{′} = y \text{?} ( 1 + {k}_{1} {r}^{2} + {k}_{2} {r}^{4} + {k}_{3} {r}^{6} ) & ( 5 )\end{matrix}$$

$$\text{?} \text{indicates text missing or illegible when filed}$$

The second distortion correction unit 406e is used when formulas (6) and (7) are used to reduce the correction accuracy compared to when the formulas (4) and (5) are used, for example. That is, the second distortion correction unit 406e according to the present embodiment uses the distortion parameters k1 and k2 without using the distortion parameter k3.

$$\begin{matrix}[ Math . 6 ] & \\ {x}^{′} = x \text{?} ( 1 + {k}_{1} {r}^{2} + {k}_{2} {r}^{4} ) & ( 6 )\end{matrix}$$

$$\begin{matrix}[ Math . 7 ] & \\ {y}^{′} = y \text{?} ( 1 + {k}_{1} {r}^{2} + {k}_{2} {r}^{4} ) & ( 7 )\end{matrix}$$

$$\text{?} \text{indicates text missing or illegible when filed}$$

In addition, the determination unit 406c acquires information on the imaging magnification of the imaging optical system 201 from the imaging unit 20. This also enables the determination unit 406c to determine which of the first distortion correction unit 406d and the second distortion correction unit 406e to use for distortion correction in accordance with the imaging magnification of the imaging optical system 201 from the imaging unit 20. The lens distortion reduces as the imaging magnification increases. Therefore, the second distortion correction unit 406e is used for distortion correction when the imaging magnification is more than a predetermined value, for example. On the other hand, the first distortion correction unit 406d is used for distortion correction when the imaging magnification is less than the predetermined value. This makes it possible to further increase the computation speed when the second distortion correction unit 406e is used for distortion correction. On the other hand, it is possible to perform distortion correction with higher accuracy when the first distortion correction unit 406d is used for distortion correction.

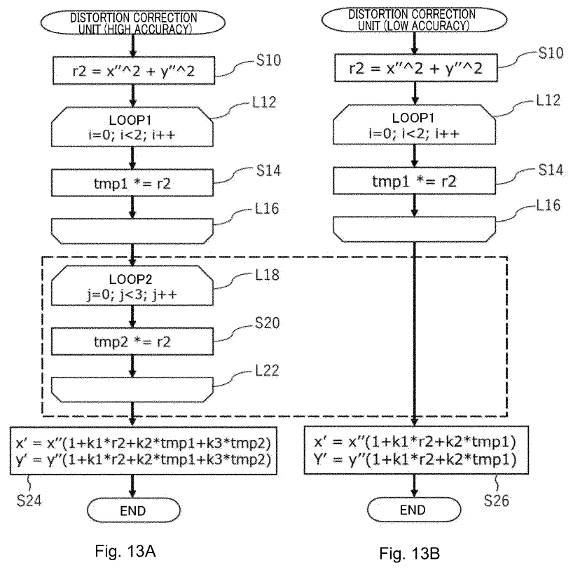

FIG. 13 is a flowchart illustrating examples of processes by the first distortion correction unit 406d and the second distortion correction unit 406e. A in the drawing illustrates an example of a process by the first distortion correction unit 406d, and B in the drawing illustrates an example of a process by the second distortion correction unit 406e.

As illustrated in FIG. 13, the first distortion correction unit 406d computes r to the second power in the formulas (4) and (5) (step S10). Next, r to the fourth power in the formulas (4) and (5) is computed between loops L12 and L16 as loop 1 (step S14). Next, r to the sixth power in the formulas (4) and (5) is computed between loops L18 and L22 as loop 2 (step S20). Then, a correction computation process is performed in accordance with the formulas (4) and (5) step (S24). For example, the computation includes 21 multiplications and 9 additions.

Meanwhile, the second distortion correction unit 406e computes r to the second power in the formulas (6) and (7) (step S10). Next, r to the fourth power in the formulas (6) and (7) is computed between loops L12 and L16 as loop 1 (step S14). Then, a correction computation process is performed in accordance with the formulas (6) and (7) step (S26). For example, the computation includes 11 multiplications and 5 additions. As can be understood from these, the second distortion correction unit 406e does not have loop 2 in which r to the sixth power is computed, and thus enables high-speed computation compared to the first distortion correction unit 406d.

In addition, the determination unit 406c may change the correction formulas in accordance with the correction accuracy required for the subsequent processing, making it possible to maintain the correction accuracy in the subsequent processing. While the present embodiment does not handle the distortion parameters p1 and p2 for the circumferential direction, the accuracy is affected only slightly when the product manufacturing accuracy is maintained. Therefore, when the computation speed is regarded as important, it is possible to reduce the circuit size and increase speed by not handling such parameters.

In the present embodiment, as described above, the number of distortion parameters to be used for correction in the correction process by the lens distortion correction unit 406 is changed in accordance with the distortion of an image. This makes it possible to reduce the number of correction parameters and increase the processing speed in accordance with the level of correction.

### Third Embodiment

A light detection device 1 according to a third embodiment is different from the light detection device 1 according to the second embodiment in performing distance measurement for a corrected image that has been subjected to a distortion correction process by the second distortion correction unit 406e, and thereafter the first distortion correction unit 406d performing a distortion correction process with an increased number of distortion parameters. The differences from the light detection device 1 according to the second embodiment will be described below.

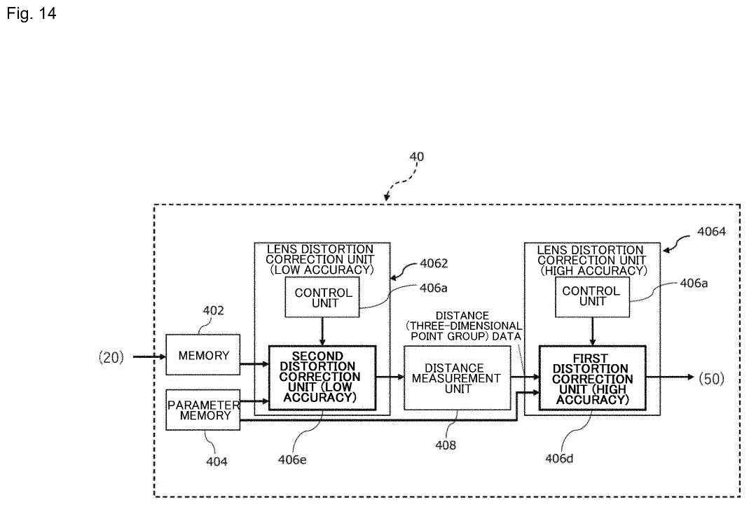

FIG. 14 is a block diagram illustrating an example of the configuration of a signal processing unit 40 according to the third embodiment. As illustrated in FIG. 14, the signal processing unit 40 according to the third embodiment includes a first lens distortion correction unit 4062 and a second lens distortion correction unit 4064. The first lens distortion correction unit 4062 includes a control unit 406a and a second distortion correction unit 406e. The second lens distortion correction unit 4064 includes a control unit 406a and a first distortion correction unit 406d.

In the light detection device 1 according to the third embodiment, the second distortion correction unit 406e performs for a captured image I10. Then, the distance measurement unit 408 performs a distance measurement process for the captured image after being corrected. That is, the process up to this point is equivalent to the process on the low-accuracy side by the signal processing unit 40 according to the second embodiment, and can increase speed.

Then, the first distortion correction unit 406d performs a correction process for data at the (x, y) coordinate of three-dimensional distance measurement data generated by the distance measurement unit 408. In this case, since three-dimensional distance measurement data generated by the distance measurement unit 408 are used, the correction process by the first distortion correction unit 406d can be performed at a higher speed, since the number of points to be processed has been reduced to the number of characteristic points.

In the present embodiment, as described above, distance measurement is performed for a corrected image that has been subjected to a correction process by the second distortion correction unit 406e, and thereafter the first distortion correction unit 406d performing with an increased number of distortion parameters. This allows the number of points to be processed by the first distortion correction unit 406d to be reduced to the number of characteristic points, enabling the process to be performed at a higher speed.

### Fourth Embodiment

A light detection device 1 according to a fourth embodiment is different from the light detection device 1 according to the first embodiment in extracting a region of interest (ROI) from the captured image data I10 and performing a distance measurement process for captured image data I10a obtained by restricting the processing range of the captured image data I10a. The differences from the light detection device 1 according to the first embodiment will be described below.

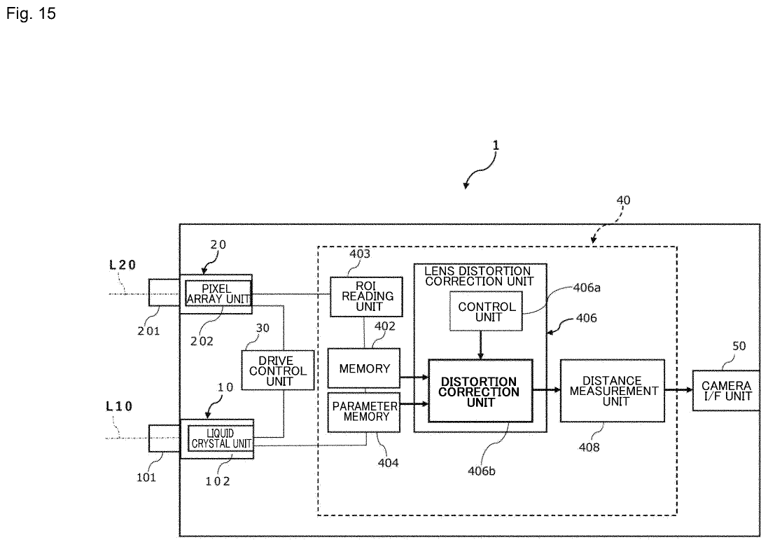

FIG. 15 is a block diagram illustrating an example of the configuration of the light detection device 1 according to the fourth embodiment. As illustrated in FIG. 15, a signal processing unit 40 according to the fourth embodiment further includes an ROI reading unit 403. The ROI reading unit 403 according to the present embodiment corresponds to a region-of-interest reading unit.

The ROI reading unit 403 restricts the processing range of the captured image data I10 to be used by the signal processing unit 40. The processing range may be a range set in advance, or may be a range from which a measurement target is extracted through a recognition process. A general-purpose process can be used for the recognition process. When the measurement target is the face of a person, for example, a common face extraction process algorithm can be used.

The ROI reading unit 403 reduces the volume of the captured image data I10 by cutting out a region of interest from the captured image data I10, for example, and stores the resulting data in the memory 402. After cutting out data, the process can be performed in a manner similar to the light detection device 1 according to the first embodiment. The distortion correction unit 406b may use the formulas (4) and (5) in which the distortion parameters p1 and p2 are not used, for example.

Alternatively, the ROI reading unit 403 may store coordinate information that indicates the region of interest in the memory 402 together with the captured image data I10. In this case, the process can be performed for the captured image data 110 in the range indicated by the coordinate information that indicates the region of interest in a manner similar to the light detection device 1 according to the first embodiment.

In the present embodiment, as described above, the ROI reading unit 403 extracts a region of interest (ROI) from the captured image data I10, and restricts the processing range of the captured image data I10. This enables the signal processing unit 40 to limit the processing range, further increasing the computation speed.

### Fifth Embodiment

A light detection device 1 according to a fifth embodiment is different from the light detection device 1 according to the first embodiment in performing a correction process for three-dimensional data after distance measurement is performed by the distance measurement unit 408. The differences from the light detection device 1 according to the first embodiment will be described below.

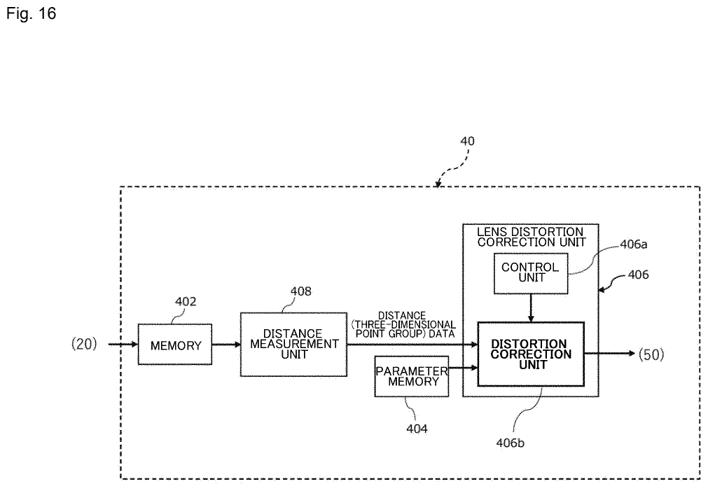

FIG. 16 is a block diagram illustrating an example of the configuration of a signal processing unit 40 according to the fifth embodiment. In the signal processing unit 40 according to the fifth embodiment, as illustrated in FIG. 16, the distortion correction unit 406b performs distortion correction for three-dimensional data after distance measurement is performed by the distance measurement unit 408.

The distortion correction unit 406b performs distortion correction using the formulas (4) and (5), for example, for the plane coordinate (x, y) of three-dimensional data generated by the distance measurement unit 408. In this case, the number of two-dimensional coordinates of three-dimensional data generated by the distance measurement unit 408 has been reduced to the number of characteristic points, and thus the computation process by the distortion correction unit 406b can be performed at a higher speed. In addition, since the value of the z coordinate before correction is also correlated with the plane coordinate (x, y) after distortion correction, and thus the distortion correction unit 406b generates data after distortion correction as three-dimensional data.

In the present embodiment, as described above, the distortion correction unit 406b performs distortion correction for three-dimensional data after distance measurement is performed by the distance measurement unit 408. This allows the number of data to be subjected to a correction process by the distortion correction unit 406b to be reduced in accordance with the number of characteristic points, and thus the computation process by the distortion correction unit 406b can be performed at a higher speed.

### Sixth Embodiment

A light detection device 1 according to a sixth embodiment is different from the light detection device 1 according to the second embodiment in that a part of a processing circuit is shared between the first distortion correction unit 406d and the second distortion correction unit 406e. The differences from the light detection device 1 according to the second embodiment will be described below.

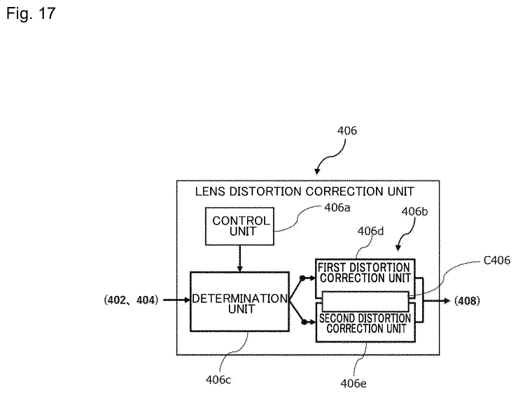

FIG. 17 is a block diagram illustrating an example of the configuration of a lens distortion correction unit 406 according to the sixth embodiment. In the lens distortion correction unit 406 according to the sixth embodiment, as illustrated in FIG. 12, a processing circuit C406 is shared as a part of a processing circuit between the first distortion correction unit 406d and the second distortion correction unit 406e.

For example, a circuit that computes r to the second power and r to the fourth power in the formulas (4) and (6) is shared. Similarly, a circuit that computes r to the second power and r to the fourth power in the formulas (5) and (7) is shared.

This makes it possible to further reduce the circuit size of the signal processing unit 40.

### Seventh Embodiment

A light detection system 1000 according to a seventh embodiment is different from the light detection device 1 according to the first embodiment in that the light detection device 1 according to the first embodiment is constituted as a system. The differences from the light detection device 1 according to the first embodiment will be described below.

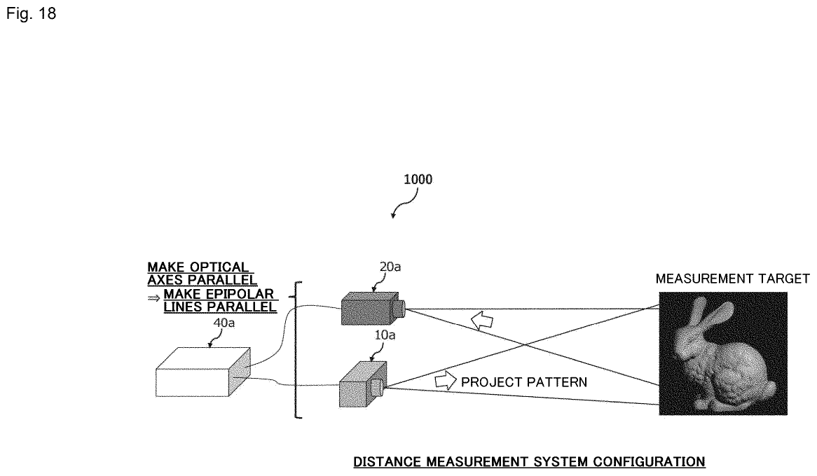

FIG. 18 illustrates an example of the configuration of the light detection system 1000 according to the seventh embodiment. As illustrated in FIG. 18, the light detection system 1000 according to the seventh embodiment includes a projection device 10a, an imaging device 20a, and a processing device 40a. The projection device 10a is a projector, for example, and has a configuration equivalent to that of the projection unit 10.

The imaging device 20a is a camera, for example, and has a configuration equivalent to that of the imaging unit 20. The processing device 40a is a processor, for example, and has a configuration equivalent to that of the signal processing unit 40. That is, the optical axis of the projection optical system of the projection device 10a and the optical axis of the imaging optical system of the imaging device 20a are parallel. In addition, the processing device 40a includes a lens distortion correction unit 406 that corrects distortion of two-dimensional coordinates based on image data captured by the imaging device 20a. That is, the lens distortion correction unit 406 can correct image data such that an epipolar line approximates to a straight line.

In this manner, the light detection system 1000 can be configured such that the projection device 10a, the imaging device 20a, and the processing device 40a are independent devices. When the projection device 10a, the imaging device 20a, and the processing device 40a are independent devices in this manner, it is possible to freely change the arrangement of the projection device 10a, the imaging device 20a, and the processing device 40a. The processing device 40a can be configured to have a configuration equivalent to that of the signal processing unit 40 of the light detection device 1 according to the first embodiment.

### Eighth Embodiment

A light detection system 1000a according to an eighth embodiment is different from the light detection system 1000 according to the seventh embodiment in further including an imaging device 20b that enables capturing in stereo. The differences from the light detection system 1000 according to the seventh embodiment will be described below.

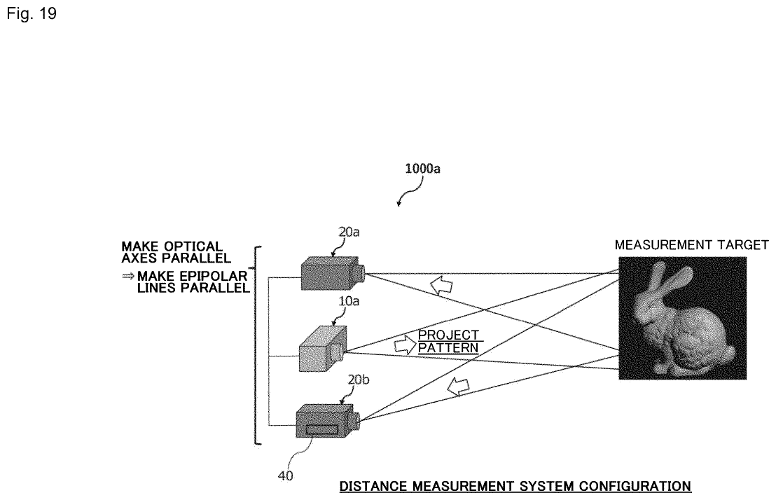

FIG. 19 illustrates an example of the configuration of the light detection system 1000a according to the eighth embodiment. As illustrated in FIG. 19, the light detection system 1000a according to the eighth embodiment includes a projection device 10a, an imaging device 20a, and an imaging device 20b. The optical axis of an imaging optical system of the imaging device 20a is parallel to the optical axis of an imaging optical system of the imaging device 20b. That is, an epipolar line of the imaging device 20a and an epipolar line of the imaging device 20b are parallel. The imaging device 20b also has a configuration equivalent to that of the signal processing unit 40. The signal processing unit 40 performs distortion correction for captured image data from the imaging device 20a and the imaging device 20b. That is, the lens distortion correction unit 406 of the signal processing unit 40 can correct image data such that epipolar lines in captured image data from the imaging device 20a and the imaging device 20b approximate to a straight line.

Then, the signal processing unit 40 generates distance image data using characteristic points from the captured image data after the distortion correction. In this manner, it is possible to further increase the computation processing speed also for the light detection system 1000a in which the imaging device 20a and the imaging device 20b are configured independently, by performing distortion correction for captured image data from the imaging device 20a and the imaging device 20b.

The present technique can also take on the following configurations.

(1) A light detection device including:
an imaging unit that captures a measurement range in which a projection image having a pattern determined in advance is projected; and
a signal processing unit that generates three-dimensional distance data for the measurement range on the basis of captured image data captured by the imaging unit, in which
the signal processing unit includes a distortion correction unit that corrects distortion of a two-dimensional coordinate based on the captured image data.

(2) The light detection device according to (1), further including a projection unit that projects the projection image.

(3) The light detection device according to (2), in which:
the imaging unit includes an imaging optical system;
the projection unit includes a projection optical system; and
an optical axis of the imaging optical system and an optical axis of the projection optical system are parallel.

(4) The light detection device according to (3), in which the distortion correction unit performs distortion correction in accordance with r to the second power based on an x coordinate of the captured image data to the second power and a y coordinate of the captured image data to the second power.

(5) The light detection device according to (3), in which the signal processing unit further includes a distance measurement unit that generates three-dimensional distance data for the measurement range on the basis of the captured image data that have been subjected to a distortion correction process by the distortion correction unit.

(6) The light detection device according to (5), in which the distortion correction unit corrects the captured image data such that an epipolar line approximates to a

(7) The light detection device according to (6), in which:
the distortion correction unit includes
a first distortion correction unit that corrects the captured image data such that an epipolar line approximates to a straight line, and
a second distortion correction unit that has a high computation speed and a suppressed correction accuracy compared to the first distortion correction unit; and
the distortion correction unit performs distortion correction by selecting one of the first distortion correction unit and the second distortion correction unit in accordance with a predetermined condition.

(8) The light detection device according to (7), in which the distortion correction unit further includes a determination unit that determines which of the first distortion correction unit and the second distortion correction unit to use in accordance with a predetermined condition.

(6) The light detection device according to (8), in which the determination unit determines which of the first distortion correction unit and the second distortion correction unit to use in accordance with an imaging magnification of the imaging optical system.

(10) The light detection device according to (9), in which:
the distortion correction unit is capable of performing distortion correction in accordance with r to the second power based on an x coordinate of the captured image data to the second power and a y coordinate of the captured image data to the second power;
the first distortion correction unit performs distortion correction on the basis of r to the second power, r to the fourth power, and r to the sixth power; and
the second distortion correction unit performs distortion correction on the basis of r to the second power and r to the fourth power.

(11) The light detection device according to (10), in which the distance measurement unit extracts a characteristic point in one direction of the captured image data after the distortion correction.

(12) The light detection device according to (11), in which the distance measurement unit generates the three-dimensional distance data using a principle of triangulation.

(13) The light detection device according to (11), in which the signal processing unit includes:
a second distortion correction unit that corrects the captured image data such that an epipolar line in the captured image data approximates to a straight line;
a distance measurement unit that generates the three-dimensional distance data on the basis of the captured image data that have been subjected to distortion correction by the second distortion correction unit; and
a first distortion correction unit that corrects a two-dimensional coordinate of the three-dimensional distance data such that an epipolar line at the two-dimensional coordinate further approximates to a straight line.

(14) The light detection device according to (1), further including a region-of-interest reading unit that restricts a range of image data, in which the signal processing unit generates three-dimensional distance data for the measurement range in the restricted range.

(15) The light detection device according to (1), in which:
the signal processing unit further includes a distance measurement unit that generates the three-dimensional distance data on the basis of the captured image data; and
the distortion correction unit corrects a two-dimensional coordinate of the three-dimensional distance data such that an epipolar line at the two-dimensional coordinate approximates to a straight line.

(16)

The light detection device according to (10), in which the first distortion correction unit and the second distortion correction unit share a processing unit that computes r to the second power and r to the fourth power.

(17) A light detection system including:
a projection device that projects a projection pattern determined in advance in a measurement range via a projection optical system;
an imaging device that captures the measurement range in which the projection pattern is projected via an imaging optical system; and
a processing device that generates three-dimensional distance data for the measurement range on the basis of captured image data captured by the imaging device, in which
the processing device includes a distortion correction unit that corrects distortion of a two-dimensional coordinate based on the captured image data.

(18) The light detection system according to (17), in which:
an optical axis of the projection optical system and an optical axis of the imaging optical system are parallel; and
the distortion correction unit corrects the captured image data such that an epipolar line approximates to a straight line.

(19) A light detection system including:
a projection device that projects a projection pattern determined in advance in a measurement range via a projection optical system;
a first imaging device that captures the measurement range in which the projection pattern is projected via a first imaging optical system; and
a second imaging device that captures the measurement range in which the projection pattern is projected via a second imaging optical system, in which:
the second imaging device includes a signal processing unit that generates three-dimensional distance data for the measurement range on the basis of first captured image data captured by the first imaging device and second captured image data captured by the second imaging device; and
the signal processing unit includes a distortion correction unit that corrects distortion of a two-dimensional coordinate of the first captured image data and a two-dimensional coordinate of the second captured image data.

(20) A program that causes an information processing device to perform processing including:
The light detection system according to (19), in which:
an optical axis of the first imaging optical system and an optical axis of the second imaging optical system are parallel; and
the distortion correction unit corrects the first captured image data and the second captured image data such that an epipolar line approximates to a straight line.

Aspects of the present disclosure are not limited to the aforementioned individual embodiments and include various modifications that could be conceived of by a person skilled in the art, and effects of the present disclosure are also not limited to those described above. In other words, various additions, modifications, and partial deletions can be made without departing from the conceptual idea and the gist of the present disclosure that can be derived from the content defined in the claims and the equivalents thereof.

### REFERENCE SIGNS LIST

1 Light detection device
10 Projection unit
10a Projection device
20 Imaging unit
20a, 20b Imaging device
40 Signal processing unit
40a Processing device
101 Projection optical system
201 Imaging optical system
406 Lens distortion correction unit
406c Determination unit
406d First distortion correction unit
406e Second distortion correction unit
408 Distance measurement unit
1000, 1000a Light detection system.

1. A light detection device comprising:
an imaging unit that captures a measurement range in which a projection image having a pattern determined in advance is projected; and
a signal processing unit that generates three-dimensional distance data for the measurement range on the basis of captured image data captured by the imaging unit, wherein
the signal processing unit includes a distortion correction unit that corrects distortion of a two-dimensional coordinate based on the captured image data.

2. The light detection device according to claim 1, further comprising a projection unit that projects the projection image.

3. The light detection device according to claim 2, wherein:
the imaging unit includes an imaging optical system;
the projection unit includes a projection optical system; and
an optical axis of the imaging optical system and an optical axis of the projection optical system are parallel.

4. The light detection device according to claim 3, wherein the distortion correction unit performs distortion correction in accordance with r to the second power based on an x coordinate of the captured image data to the second power and a y coordinate of the captured image data to the second power.

5. The light detection device according to claim 3, wherein the signal processing unit further includes a distance measurement unit that generates three-dimensional distance data for the measurement range on the basis of the captured image data that have been subjected to a distortion correction process by the distortion correction unit.

6. The light detection device according to claim 5, wherein the distortion correction unit corrects the captured image data such that an epipolar line approximates to a

7. The light detection device according to claim 6, wherein:
the distortion correction unit includes
a first distortion correction unit that corrects the captured image data such that an epipolar line approximates to a straight line, and
a second distortion correction unit that has a high computation speed and a suppressed correction accuracy compared to the first distortion correction unit; and
the distortion correction unit performs distortion correction by selecting one of the first distortion correction unit and the second distortion correction unit in accordance with a predetermined condition.

8. The light detection device according to claim 7, wherein the distortion correction unit further includes a determination unit that determines which of the first distortion correction unit and the second distortion correction unit to use in accordance with a predetermined condition.

9. The light detection device according to claim 8, wherein the determination unit determines which of the first distortion correction unit and the second distortion correction unit to use in accordance with an imaging magnification of the imaging optical system.

10. The light detection device according to claim 9, wherein:
the distortion correction unit is capable of performing distortion correction in accordance with r to the second power based on an x coordinate of the captured image data to the second power and a y coordinate of the captured image data to the second power;
the first distortion correction unit performs distortion correction on the basis of r to the second power, r to the fourth power, and r to the sixth power; and
the second distortion correction unit performs distortion correction on the basis of r to the second power and r to the fourth power.

11. The light detection device according to claim 10, wherein the distance measurement unit extracts a characteristic point in one direction of the captured image data after the distortion correction.

12. The light detection device according to claim 11, wherein the distance measurement unit generates the three-dimensional distance data using a principle of triangulation.

13. The light detection device according to claim 11, wherein the signal processing unit includes:
a second distortion correction unit that corrects the captured image data such that an epipolar line in the captured image data approximates to a straight line;
a distance measurement unit that generates the three-dimensional distance data on the basis of the captured image data that have been subjected to distortion correction by the second distortion correction unit; and
a first distortion correction unit that corrects a two-dimensional coordinate of the three-dimensional distance data such that an epipolar line at the two-dimensional coordinate further approximates to a straight line.

14. The light detection device according to claim 1, further comprising a region-of-interest reading unit that restricts a range of image data, wherein the signal processing unit generates three-dimensional distance data for the measurement range in the restricted range.

15. The light detection device according to claim 1, wherein:
the signal processing unit further includes a distance measurement unit that generates the three-dimensional distance data on the basis of the captured image data; and
the distortion correction unit corrects a two-dimensional coordinate of the three-dimensional distance data such that an epipolar line at the two-dimensional coordinate approximates to a straight line.

16. The light detection device according to claim 10, wherein the first distortion correction unit and the second distortion correction unit share a processing unit that computes r to the second power and r to the fourth power.

17. A light detection system comprising:
a projection device that projects a projection pattern determined in advance in a measurement range via a projection optical system;
an imaging device that captures the measurement range in which the projection pattern is projected via an imaging optical system; and
a processing device that generates three-dimensional distance data for the measurement range on the basis of captured image data captured by the imaging device, wherein
the processing device includes a distortion correction unit that corrects distortion of a two-dimensional coordinate based on the captured image data.

18. The light detection system according to claim 17, wherein:
an optical axis of the projection optical system and an optical axis of the imaging optical system are parallel; and
the distortion correction unit corrects the captured image data such that an epipolar line approximates to a straight line.

19. A light detection system comprising:
a projection device that projects a projection pattern determined in advance in a measurement range via a projection optical system;
a first imaging device that captures the measurement range in which the projection pattern is projected via a first imaging optical system; and
a second imaging device that captures the measurement range in which the projection pattern is projected via a second imaging optical system, wherein:
the second imaging device includes a signal processing unit that generates three-dimensional distance data for the measurement range on the basis of first captured image data captured by the first imaging device and second captured image data captured by the second imaging device; and
the signal processing unit includes a distortion correction unit that corrects distortion of a two-dimensional coordinate of the first captured image data and a two-dimensional coordinate of the second captured image data.

20. The light detection system according to claim 19, wherein:
an optical axis of the first imaging optical system and an optical axis of the second imaging optical system are parallel; and
the distortion correction unit corrects the first captured image data and the second captured image data such that an epipolar line approximates to a straight line.
